(19) United States
(12) Patent Application Publication
(10) Pub. No.: US 2023/0231339 A1
(43) Pub. Date: Jul. 20, 2023

(54) MODULAR PLUG CONNECTOR

(71) Applicant: Stäubli Electrical Connectors AG, Allschwil (CH)

(72) Inventors: Alexander DOPPLER, Allschwil (CH); Sylvestre KIRY, Leymen (FR)

(73) Assignee: Stäubli Electrical Connectors AG, Allschwil (CH)

(21) Appl. No.: 18/011,001

(22) PCT Filed: Jun. 8, 2021
(86) PCT No.: PCT/EP2021/065244

§ 371 Date: Dec. 16, 2022

(30) Foreign Application Priority Data
Jun. 18, 2020 (EP) 20180815.1
Jun. 18, 2020 (EP) 20180821.9

(51) Int. Cl. H01R 13/514; H01R 13/518; H01R 13/627

(52) U.S. Cl. CPC H01R 13/514; H01R 13/518; H01R 13/6271; H01R 13/506

(57) ABSTRACT

A modular plug connector having a holding frame having side walls which laterally delimit a receiving space, and at least one plug connector module which can be introduced into the receiving space. The side walls have a plurality of holding-frame-side guide elements and the at least one plug connector module has at least one plug-connector-module-side guide element. The at least one plug-connector-module-side guide element can be plugged into the holding-frame-side guide elements such that the plug connector module is positioned in the receiving space. The side walls have a latching structure and the plug connector module has at least one latching tongue which engages into the latching structure. The at least one plug connector module has at least one functional element with which functional element a functional contact to a functional element of a plug connector module of another plug connector can be established.

### TECHNICAL FIELD

The present invention relates to a modular plug connector according to the preamble of claim 1.

### PRIOR ART

Modular plug connectors are known from the prior art. By way of example, EP 0 742 608 discloses such a plug connector. In this case, module parts, in which the electrical conductor elements are arranged, are connected to a frame. The module parts are then secured with respect to the holding frame by a latching lug. The disadvantage of the plug connector according to EP 0 742 608 is, for example, the imprecise positioning of the individual modules.

A further plug connector, having modules which are fastened to a base element, is known from JP-H09-147960. This is disadvantageous in that latching elements are located on the inside, which is a disadvantage with regard to the accessibility.

### SUMMARY OF THE INVENTION

Starting with this prior art, an object of the invention is to provide a modular plug connector which overcomes the disadvantages of the prior art. In particular, an object of the present invention is to provide a modular plug connector whereof the plug connector modules can be assembled more easily.

This object is achieved by the subject matter of claim 1. Accordingly, a modular plug connector comprises a holding frame having two side walls, which extend parallel to one another and which delimit a receiving space laterally, and at least one plug connector module, which can be installed in the receiving space. The side walls have a plurality of holding-frame-side guide elements on the inner sides facing the receiving space, and the at least one plug connector module has at least one plug-connector-module-side guide element on its outer side. The at least one plug-connector-module-side guide element can be plugged into the holding-frame-side guide elements and, more precisely, in such a way that the plug connector module is mounted in a positionally precise manner in the receiving space. The side walls have a latching structure on their outer sides and the plug connector module has at least one latching lug, which engages in the latching structure outside the receiving space. The at least one plug connector module comprises at least one functional element, such as an electrical functional element or an optical functional element or a fluidic functional element, via which functional element a functional contact with a functional element of a plug connector module of a further plug connector can be established in the mated state.

As a result of arranging the guide elements inside the receiving space, the guide elements are well protected from external mechanical influences. The arrangement of the latching structure on the outer side is advantageous in that the latching lug remains easily accessible and an individual plug connector module may be assembled and replaced comparatively easily.

Two modular plug connectors according to the present invention can be connected to one another and then form a plug connector arrangement. In other words, in a plug connector arrangement, a first plug connector according to the invention is connected to a second plug connector according to the invention. The functional elements are designed accordingly such that a functional contact is established between the functional elements of the first plug connector and the functional elements of the second plug connector. In this case, the description below is applicable to both the first and the second plug connector. In this case, the first and the second plug connector can be connected to one another along a linear plug-in direction.

The expression “functional element’ is understood to mean, for example, an electrical plug connector with a pin side or a matching socket side. In this case, the pin side is in a plug connector module of a first plug connector and the socket side is in a plug connector module of a second plug connector which is connected to the first plug connector. Data signals, or also electrical energy, may be transmitted via the electrical plug connector. However, the functional element may also be a fluidic, in particular a pneumatic, functional element. With regard to the allocation of plug connector modules designed as socket sides and plug connector modules designed as plug sides, it is conceivable to allocate all socket sides to one holding frame and all plug sides to another holding frame. However, it is also possible to arrange socket sides and plug sides on one holding frame.

The latching structure on the outer side is preferably a groove extending completely over the entire length of the side wall. This is advantageous in that a single latching structure may be provided for all plug connector modules to be installed, irrespective of their position in the holding frame.

The latching lug of the plug connector module, when connected to the holding frame, preferably comes to lie on the outer side of the holding frame. It is thus possible to establish particularly good accessibility.

Two latching lugs are preferably provided for each plug connector module, wherein one latching lug comes into engagement with the latching structure of one side wall and the other latching lug comes into engagement with the latching structure of the other side wall. The plug connector module is thus connected to the holding frame on both sides, which ensures good mounting of the plug connector module.

The latching lug preferably has a width which extends over the entire width of the plug connector module. However, the latching lug is particularly preferably not wider than the width of the plug connector module. As a result of this design, the rigidity and therefore also the robustness against external influences may be improved.

The outer side of the side wall preferably has, in the region in which the latching lug comes to lie, a depression region which extends from an outer lateral surface of the outer side into the side wall, wherein the depression region and the latching lug are designed in such a way that the latching lug substantially does not protrude beyond the outer lateral surface, in particular in such a way that the latching lug is substantially flush with the outer lateral surface. The latching lugs are embedded as a result of the depression region, whereby a compact structure is produced on the one hand and whereby a structure in which the latching lugs cannot be easily released is produced on the other.

The side wall preferably has, on its rear end face, a first positioning element, which cooperates with a second positioning element arranged on the plug connector module.

Arranging the positioning elements on the end surface has the further advantage that the plug connector module is guided via an additional element.

The first positioning element is particularly preferably a cam and the second positioning element is a receptacle in which the cam engages. Alternatively, the second positioning element is a cam and the first positioning element is a receptacle in which the cam engages.

The plug-connector-module-side guide element is preferably at least one guide ridge and the holding-frame-side guide element is at least one guide groove, wherein the at least one guide ridge engages in the at least one guide groove.

The guide groove and the guide ridge are therefore designed to complement or match one another.

The guide grooves and the guide ridge are preferably orientated in the same direction as the plug-in direction of the plug connector.

The guide elements on one of the two side walls are preferably designed to differ from the guide elements on the other of the two side walls in such a way that a coding for the orientation of the plug connector modules may be realized.

The guide elements particularly preferably extend over at least half the depth of the receiving space in each case. In other words, the guide elements extend over at least half the depth of the side wall.

The holding-frame-side guide elements and/or the plug-connector-module-side guide element particularly preferably have a main guide region and an insertion region, wherein the play between the plug connector module and the holding frame is greater in the insertion region than in the main guide region. A particularly advantageous structure for assembling the plug connector module may thus be established.

The at least one plug connector module preferably has a lateral surface, wherein the spacing between the lateral surface and the guide elements is designed to be such that two adjacent plug connector modules can be brought into contact with one another at the lateral surfaces. It is thus possible to make particularly good use of the available receiving space.

The holding frame preferably has two transverse walls, which are each arranged at the ends of the side walls and connect the side walls, wherein the side walls and the transverse walls are preferably designed as one piece.

The holding frame is preferably designed as a rectangle. The receiving space is preferably designed as a cuboid.

The transverse walls preferably have, on the outer side, a receptacle in which a grounding contact element is held, wherein the grounding contact element is made of an electrically conductive material. The grounding contact element serves as a grounding contact, wherein it is then connected to the grounding contact element of a second plug connector.

The holding frame preferably has a guide structure with which two holding frames are guided during the plug-in movement. The guide structure is preferably arranged on the two transverse walls. The guide structure preferably has a coding element so that incorrect mating is impossible.

The at least one plug connector module preferably has a contact side, via which the functional element is accessible for a plug-in process with another plug. The plug connector module preferably furthermore has a connection side, via which the functional element can be connected to a connection element, such as a connection cable or a connection hose. The plug connector module can preferably be installed in the receiving space with its contact side first.

That is to say, in other words, that the plug connector module can be installed in the receiving space in the plug-in direction of two plug connectors.

The latching lug preferably protrudes from the connection side.

The side walls preferably have a front end face and a rear end face, wherein the latching lug extends over the rear end face and wherein the front end face, when connected to a further plug connector, can be orientated with respect to the front end face of the further plug connector.

The plug connector module, as seen in the plug-in direction, preferably projects out of the receiving space. The plug connector module is preferably designed in such a way that, between the side wall and the plug connector module, an intermediate space is produced, into which a projecting plug connector module of a plug connector to be connected may project. In other words, the plug connector module of the first plug connector, which projects out of the receiving space, projects into the intermediate space of the second plug connector.

Further embodiments of the invention are specified in the dependent claims.

### BRIEF DESCRIPTION OF THE DRAWINGS

Preferred embodiments of the invention are described in the following with reference to the drawings, which serve merely for explanation and should not be interpreted as restrictive. In the drawings,

FIG. 1 shows a perspective view of a modular plug connector according to a particularly preferred embodiment;

FIG. 2a shows a further perspective view of the modular plug connector according to FIG. 1;

FIG. 2b shows a detailed view of a plug connector module for the modular plug connector according to one of the preceding figures;

FIG. 3 shows a perspective view of two mated plug connectors according to FIGS. 1 and 2a;

FIG. 4 shows a perspective view of the mated plug connector according to FIG. 3;

FIG. 5a shows a sectional illustration through the mated plug connector according to FIG. 4;

FIG. 5b shows a sectional illustration through the mated plug connector according to FIG. 4;

FIG. 6 shows a perspective exploded illustration of FIGS. 3 to 5; and

FIG. 7 shows a perspective view of a holding frame for a further plug connector.

### DESCRIPTION OF PREFERRED EMBODIMENTS

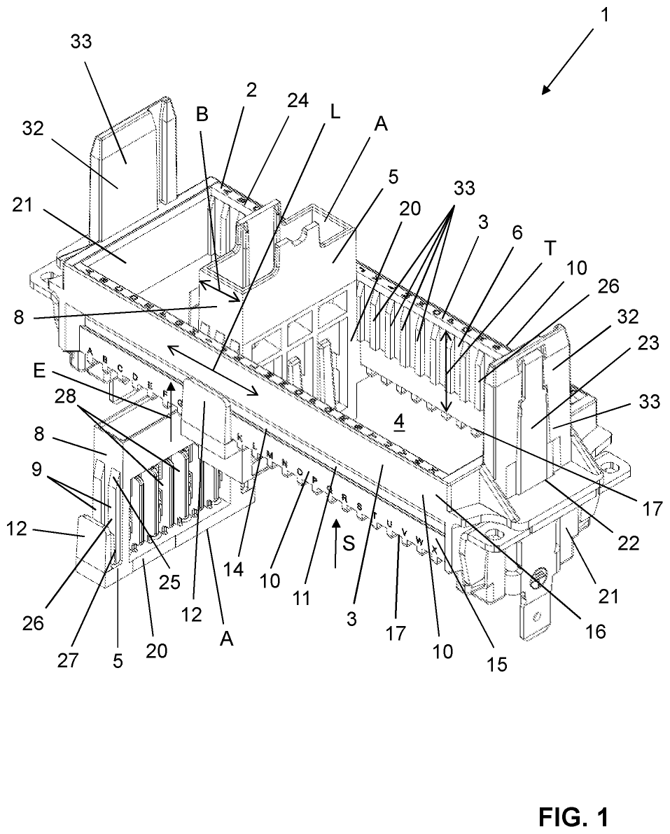

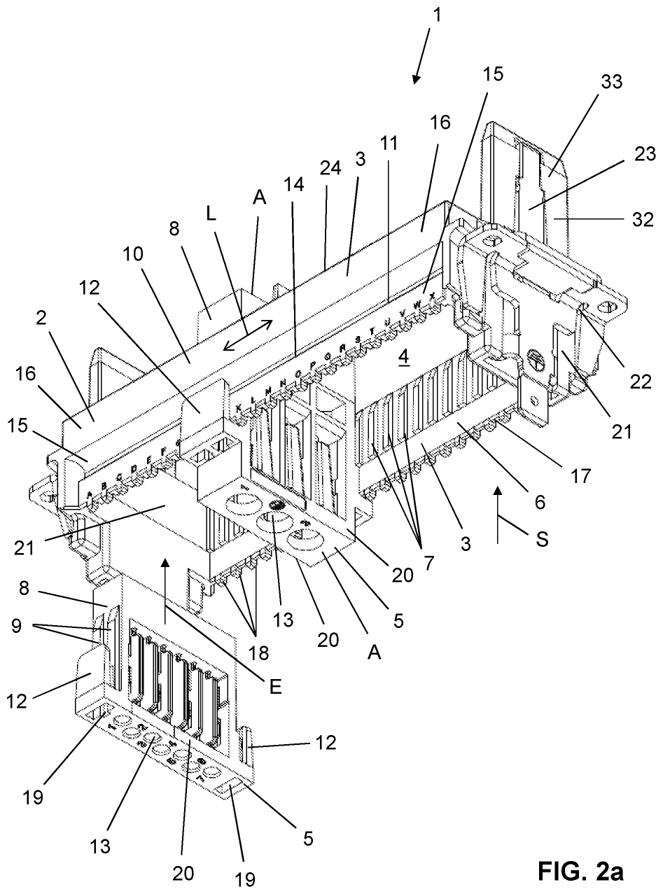

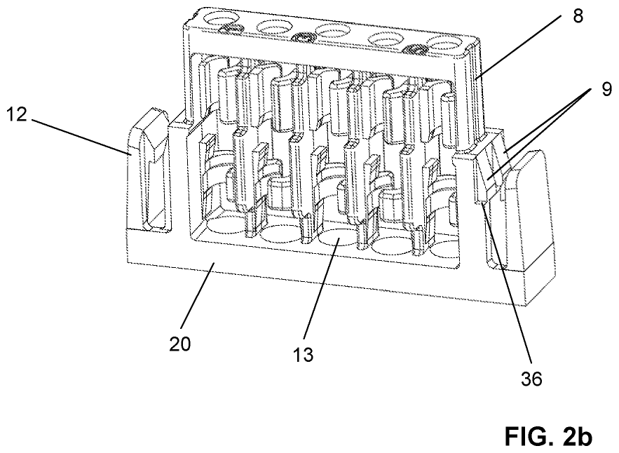

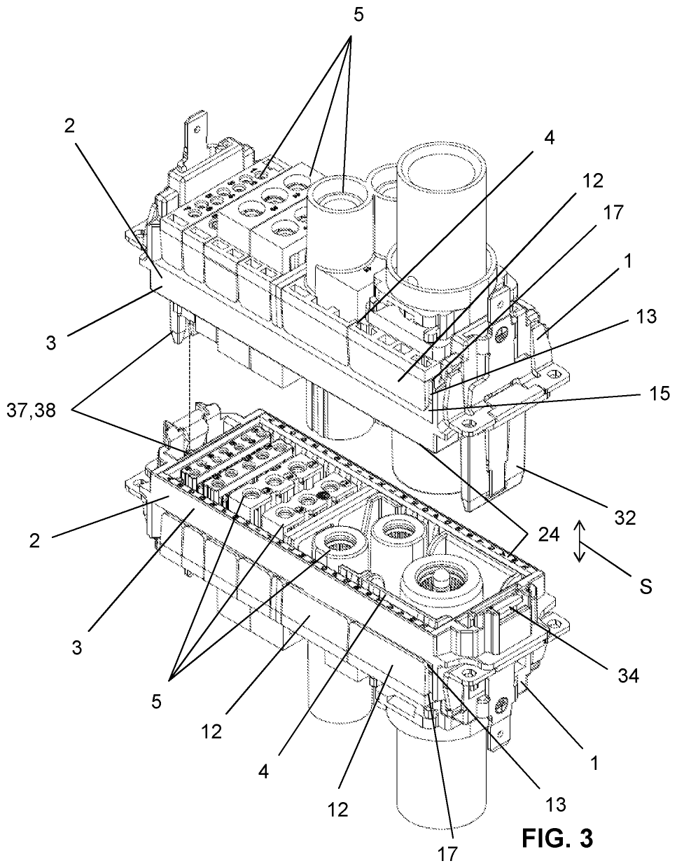

Perspective views of a modular plug connector 1 are shown in FIGS. 1 and 2a. FIGS. 3 to 6 then show two of the plug connectors 1, which may be mated with one another.

The modular plug connector 1 comprises a holding frame 2 and at least one plug connector module 5, which is mounted on the holding frame 2. Typically, a plurality of different plug connector modules 5 are mounted on the holding frame 2, wherein the type of plug connector module 5 may differ.

The holding frame 2 comprises two side walls 3, which extend parallel to one another and which delimit a receiving space 4 laterally. In this case, the side walls 3 are arranged at a spacing from one another. Transverse walls 21, which connect the two side walls 3 to one another, are arranged at the free ends of the side walls 3. In this case, the side walls 3, and also the transverse walls 21 here, delimit a receiving space 4. The receiving space 4 is designed substantially as a cuboid in the embodiment shown.

The at least one plug connector module 5 can be at least partially installed in the receiving space 4 and, as already mentioned, is mounted on the holding frame 2.

The side walls 3 have a plurality of holding-frame-side guide elements 7 on the inner sides 6 facing the receiving space 4. The at least one plug connector module 5 furthermore has at least one plug-connector-module-side guide element 9 on its outer side 8. The two guide elements 7, 9 serve for guiding the plug connector module 5 during the assembly procedure and for positionally precise mounting after assembly. In this case, the at least one plug-connector-module-side guide element 9 can be plugged into the holding-frame-side guide elements 7 and, more precisely, in such a way that the plug connector module 5 can be pushed into the receiving space 4 and is mounted in a positionally precise manner after it is pushed into the receiving space 4. The guide elements 7, 9 for the plug connector module 5 project into the receiving space 4 during a plug-in movement E.

The number of plug-connector-module-side guide elements 9 is substantially dependent on the width of the plug connector module 5.

The side walls 3 have a latching structure 11 on their outer sides 10. The plug connector module 5 furthermore has at least one latching lug 12, which engages in the latching structure 11 outside the receiving space 4.

The at least one plug connector module 5 has at least one functional element 13. The functional element 13 may be, for example, an electrical contact element, which is designed as a pin side or as a socket side. However, the functional element may also be a fluidic functional element, such as a pneumatic coupling. A functional contact may be established with the functional element in the mated state of two plug connectors 1. This is explained in more detail with reference to FIGS. 3 to 5.

In the embodiment shown, the latching structure 11 on the outer sides 10 of the side walls 3 is a groove 14 extending completely along the entire length L of the side wall 3. In this case, the groove 14 extends continuously, i.e. without a break, over the entire length L of the side wall 3. The continuous groove 14 is advantageous in that the latching lug 12 may latch accordingly in the latching structure 11 without a lateral mechanical force.

The lateral guidance and positioning transversely to the longitudinal side of the side wall 3 is provided by the guide elements 7, 9, whilst the plug connector module 5 is secured in the direction of the plug-in movement E by the latching lug 12 latching in the groove 14.

When the plug connector module 5 is connected to the holding frame 2, the latching lug 12 comes to lie on the outer side 10 of the holding frame 2 and engages accordingly in the groove 14. In this case, the latching lug 12 embraces a rear end face 18 of the side wall 3 and then projects externally with respect to the receiving space 4, along the side wall 3, until it reaches the point at which it engages in the groove 14. In other words, the latching lug 12 provides a U-shaped space 27, which surrounds parts of the side wall 3. In this case, the actual latching lug 12 is arranged on one side of this U-shaped space 27 and the plug-connector-module-side guide elements 9 are arranged on the other side.

At least two latching lugs 12 are provided for each plug connector module 5, wherein one latching lug 12 comes into engagement with the latching structure 11 of one side wall 3 and the other latching lug 12 comes into engagement with the latching structure 11 of the other side wall 3. That is to say that both side walls 3 are in connection with a respective latching structure 11 of the plug connector module 5. This bilateral and, with respect to the receiving space 4, symmetrical embracing is advantageous in that it is possible to establish good mounting of the plug connector module 5 in the receiving space 4 of the holding frame 2.

The latching lug 12 preferably has a width which extends over the entire width of the plug connector module 5. That is to say that, in a wide plug connector module 5, the latching lug 12 is also wider than in a relatively narrow plug connector module 5. However, it is also possible that the latching lug 12 has a narrower width than the plug connector module 5 or is formed in multiple parts.

Receiving points 28, in which the functional elements 13 are mounted, are arranged inside the plug connector module 5. These receiving points 28 may have any form and are substantially dependent on the shape of the functional element 13. However, the receiving points 28 are designed in such a way that the functional element 13 is typically mounted in the receiving point 28 of the plug connector module 5 in a fixed, yet replaceable, manner.

The outer side 8 of the side wall 3 has a depression region 15 in the region in which the latching lug 12 comes to lie. In this case, the depression region 15 extends from an outer lateral surface 16 of the outer side 8 into the side wall 3. In the embodiment shown, the depression region 15 extends over the entire length L of the side wall 3. In this case, the depression region 15 and the latching lug 12 are designed in such a way that the latching lug 12 does not protrude beyond the outer lateral surface 16. The latching lug 12 is particularly preferably flush with the outer lateral surface 16. The groove 14, which deepens the depression region 15 even further, is moreover arranged in the said depression region 15.

The side wall 3 furthermore has at least one first positioning element 18 on its rear end face 17. In this case, this first positioning element 18 cooperates with at least one second positioning element 19 arranged on the plug connector module 5. In the embodiment shown, the first positioning element 18 is a cam and the second positioning element 19 is a receptacle into which the cam extends. In the embodiment shown, the positioning element 18 is offset in the longitudinal direction L with respect to holding-frame-side guide element 7 and additionally helps to prevent the plug connector modules from tilting.

The plug-connector-module-side guide element 9 is designed as a guide ridge in the embodiment shown. The holding-frame-side guide element 7 is designed as a guide groove in the embodiment shown. In this case, the guide ridge may be pushed into the guide groove and therefore engages in the guide groove. In this case, all guide elements 7, 9 extend parallel to one another. The guide elements 7 on one of the two side walls 3 may be designed to differ from the guide elements 7 on the other of the two side walls 3. A coding for the orientation of the plug connector modules 5 with respect to the receiving space 4 may thus be provided. That is to say that the plug connector modules 5 may only be installed in the receiving space 4 in one orientation.

The grid spacing between the guide grooves is preferably less than 5 millimeters, preferably in a range of 2 to 4 millimeters, in particular approximately 3.5 millimeters. This is advantageous in that a very finely separated grid spacing may be provided, which has a space-saving effect since the modules may be positioned in a more finely structured manner.

The holding-frame-side guide elements 7 extend over at least half the depth of the receiving space 4. That is to say, in other words, that the guide elements 7 extend over at least half the depth T of the side wall 3.

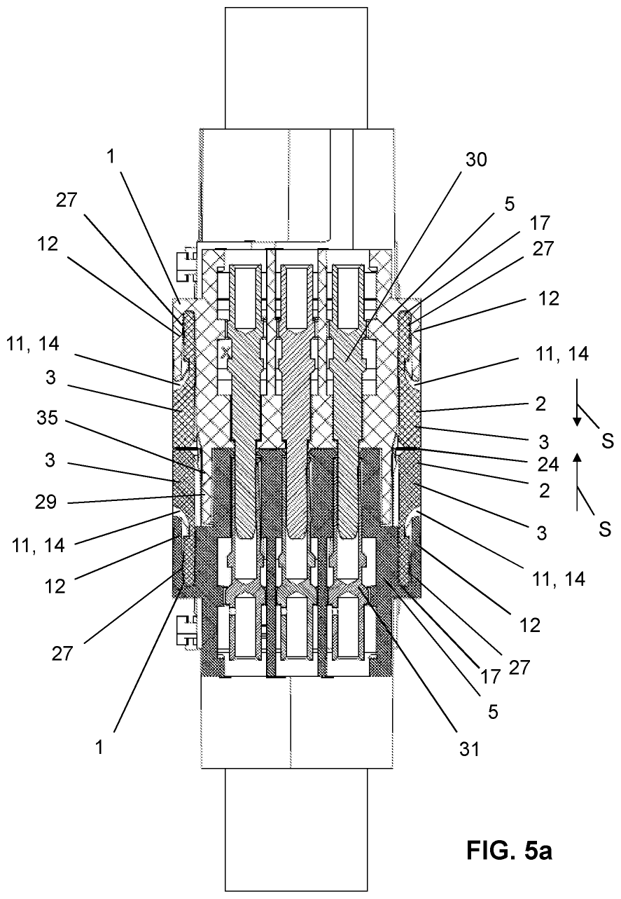

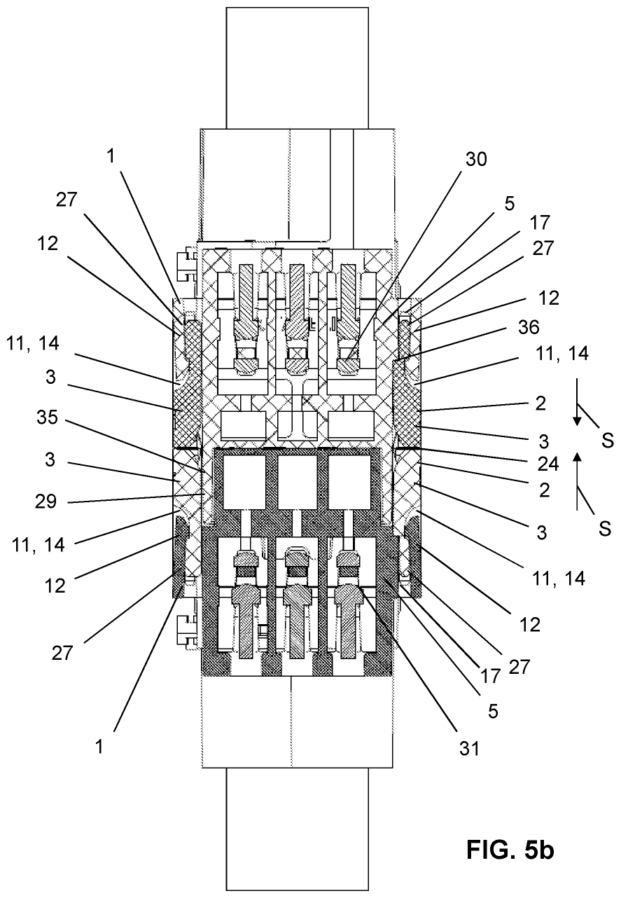

The holding-frame-side guide elements 7 on one of the side walls 3 particularly preferably extend over only part of the depth T of the side wall 3, whilst the holding-frame-side guide elements 7 on the other of the side walls 3 extend over the entire depth. The plug connector module 5 may furthermore have a coding surface 36. The coding surface 36 is shown in FIG. 2b. In this case, the coding surface 36 is arranged in such a way that, if the plug connector module 5 is pushed into the receiving space 4 incorrectly, the coding surface 36 abuts against the holding-frame-side guide elements 7, which extend over the entire depth, and may therefore not be inserted. The correct position is shown in the sectional illustration of FIG. 5b, wherein the coding surface is located in the region in which there are no holding-frame-side guide elements 7.

In the embodiment shown, the plug-connector-module-side guide elements 9 may have an insertion region 25 and a main guide region 26. In this case, the insertion region 25 is arranged in front of the main guide region 26. In the embodiment shown, the insertion region 25 is designed as an inclined plane. In this case, the play between the plug connector module 5 and the holding frame 2 in the insertion region 25 is greater than in the main guide region 26. The plug connector module 5 may thus be installed in the receiving space 4 more easily.

The holding-frame-side guide element 7 does not have an insertion region 25 in the embodiment shown, but instead comprises only the main guide region 26. However, the holding-frame-side guide element 7 may also be equipped with an insertion region 26.

The at least one plug connector module 5 has a lateral surface 20. In this case, the spacing between the lateral surface 20 and the guide elements 7, 9 is preferably such that two adjacent plug connector modules 5 may almost be brought into contact with one another in a fixed manner at their lateral surfaces 20. That is to say that there is preferably play between two adjacent plug connector modules 5 in the holding frame 2. The play is preferably kept as small as possible.

The transverse walls 21 have a receptacle 22 on the outer side. A grounding contact element 23 may be held on this receptacle. The grounding contact element 23 is preferably made of an electrically conductive material and may be used as a contact. The grounding contact elements 23 of two mated plug connectors 1 are electrically connected to one another.

Furthermore, a guide structure 32 is arranged in each case on the transverse wall 21. The guide structure 32 guides two plug connectors 1 to be mated along the plug-in movement S. As shown in FIG. 3, the guide structure 32 may be designed as a guide lug 33 in one of the plug connectors 1 and as a guide opening 34 in the other of the plug connectors 1.

In this case, the guide lug 33 may be inserted into the guide opening 34. The guide lug 33 and the guide opening 34 preferably have coding elements. These coding elements are denoted by the reference signs 37 and 38. The coding element 37 is, for example, a groove 37 and the coding element 38 is, for example, a spring 38 engaging in the groove, as shown in FIG. 3. The dashed line in FIG. 3 symbolizes the cooperation.

A modular plug connector according to the above description is shown in FIG. 3. In this case, all plug-in spots are occupied by corresponding plug connector modules 5 with different fittings. In this case, each of the plug connector modules 5 has a contact side K, via which the functional element 13 may be accessible for a plug-in process with another plug connector.

The two plug connectors 1 according to FIG. 3 may be connected to one another along a plug-in movement S. In this case, all functional elements 13 of all plug connector modules 5 are connected to one another. The contact sides K of the two plug connectors 1 then come into contact with one another in the mated state.

Opposite the contact side K, each of the plug connector modules 5 has a connection side A. The functional element 13 may be connected to a connection element (not shown in the figures), such as a connection cable or a connection hose, via this connection side A.

In the embodiment shown, the plug connection module 5 may be installed in the receiving space 4 with its contact side K first in each case. That is to say that the plug connector module 5 may be installed in the receiving space 4 in the direction of the plug-in movement S. In this case, the latching lug 12 in the embodiment shown likewise protrudes accordingly from the connection side A.

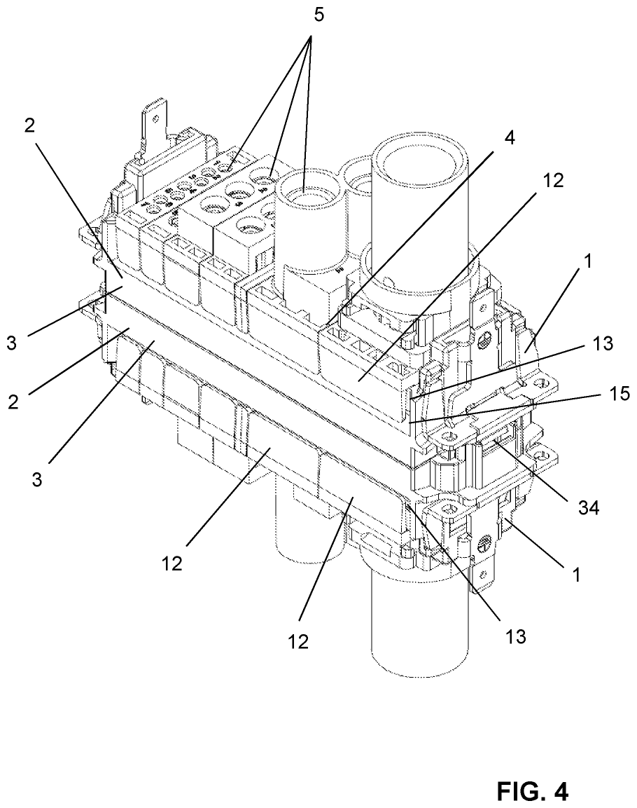

The plug connector according to FIG. 3 is shown in the mated state in FIG. 4.

FIGS. 5a and 5b shows a sectional illustration according to FIG. 4. In this illustration, it is clearly shown that the plug connector module 5 of the top plug connector 1 projects out of the receiving space 4 as seen in the plug-in direction S. In contrast, the bottom plug connector module 5 has an intermediate space 29 between the side wall 3 and the plug connector module 5. In FIGS. 5a and 5b, it is now shown that the part of the plug connector module 5 of the top plug connector 1 which projects out of the receiving space 4 projects into the intermediate space 29. This configuration is particularly advantageous if the functional elements are designed with a pin-socket configuration. In this case, in FIGS. 5a and 5b, the functional element 13 in the top plug connector 1 is designed as a pin-side functional element 30 and the functional element 13 of the bottom plug connector 1 is designed as a socket-side functional element 31. The regions of the pin-side functional element 13 which project out of the receiving space 4 may accordingly be protected from mechanical external influences by the region 35 of the plug connector module 5 which likewise projects out of the receiving space 4. Touch-protection during the plug-in procedure is moreover provided.

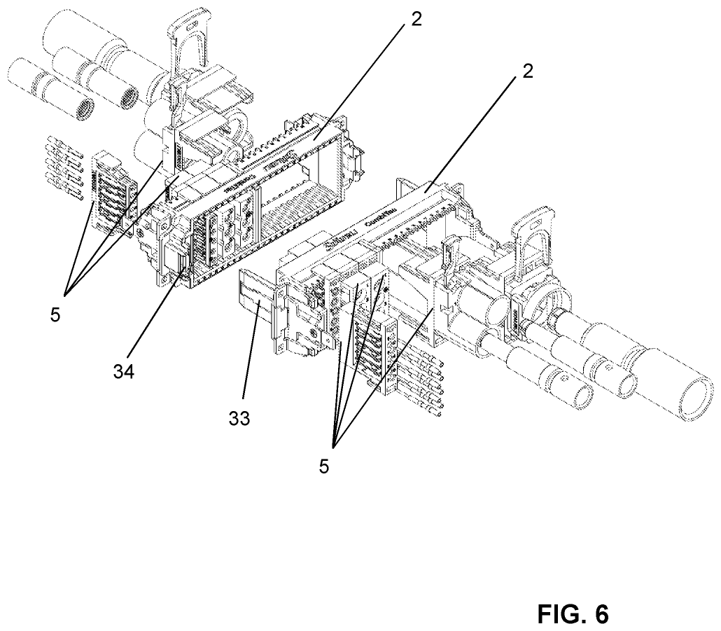

An exploded illustration of the plug connector according to FIGS. 3 to 5 is then shown in FIG. 6.

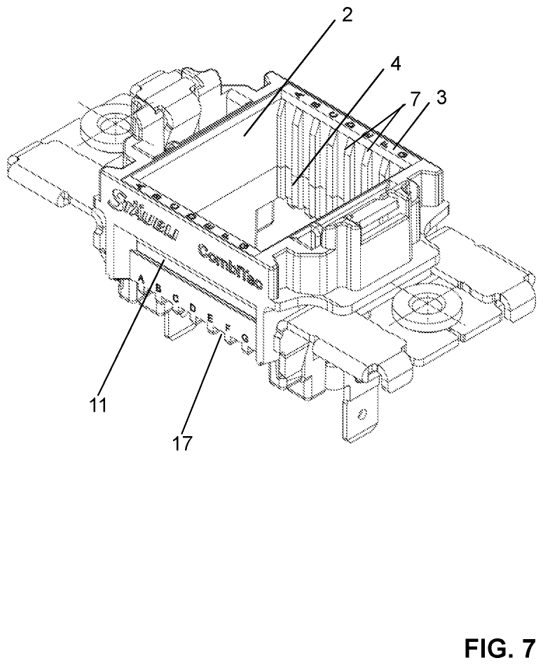

A further embodiment of a holding frame 2 is shown in FIG. 7. In this case, the length of the side walls 3 is designed to be smaller than the length of the side walls 3 of the embodiment according to FIGS. 1 to 6. It goes without saying that other lengths are likewise conceivable.

LIST OF REFERENCE SIGNS

| | | | |
|---|---|---|---|
| 1 | Plug connector | 25 | Insertion region |
| 2 | Holding frame | 26 | Main guide region |
| 3 | Side wall | 27 | U-shaped space |
| 4 | Receiving space | 28 | Receiving point |
| 5 | Plug connector module | 29 | Intermediate space |
| 6 | Inner side | 30 | Pin-side functional element |
| 7 | Holding-frame-side guide | 31 | Socket-side functional |
| | element | | element |
| 8 | Outer side | 32 | Guide structure |
| 9 | Plug-connector-module-side | 33 | Guide lug |
| | guide element | 34 | Guide opening |
| 10 | Outer side | 35 | Projecting region |
| 11 | Latching structure | 36 | Coding surface |
| 12 | Latching lug | 37 | Coding element |
| 13 | Functional element | 38 | Coding element |
| 14 | Groove | A | Connection side |
| 15 | Depression region | B | Width |
| 16 | Outer lateral surface | K | Contact side |
| 17 | Rear end face | E | Plug-in movement |
| 18 | First positioning element | T | Depth |
| 19 | Second positioning element | S | Plug-in direction |
| 20 | Lateral surface | | |
| 21 | Transverse walls | L | Length |
| 22 | Receptacle | | |
| 23 | Grounding contact element | | |
| 24 | Front end face | | |

1.-20. (canceled)

21. A modular plug connector comprising
a holding frame having two side walls, which extend parallel to one another and which delimit a receiving space laterally, and
at least one plug connector module, which can be installed in the receiving space,
wherein the side walls have a plurality of holding-frame-side guide elements on the inner sides facing the receiving space, and the at least one plug connector module has at least one plug-connector-module-side guide element on its outer side, wherein the at least one plug-connector-module-side guide element can be plugged into the holding-frame-side guide elements in such a way that the plug connector module is mounted in a positionally precise manner in the receiving space,
wherein the side walls have a latching structure on their outer sides, and the plug connector module has at least one latching lug, which engages in the latching structure outside the receiving space,
and
wherein the at least one plug connector module comprises at least one functional element, such as an electrical functional element or an optical functional element or a fluidic functional element, via which functional element a functional contact with a functional element of a plug connector module of a further plug connector can be established in the mated state.

22. The modular plug connector as claimed in claim 21, wherein the latching structure on the outer side is a groove which extends completely over the entire length of the side wall.

23. The modular plug connector as claimed in claim 21, wherein the latching lug of the plug connector module, when connected to the holding frame, comes to lie on the outer side of the holding frame.

24. The modular plug connector as claimed in claim 21, wherein two latching lugs are provided for each plug connector module, wherein one latching lug comes into engagement with the latching structure of one side wall and the other latching lug comes into engagement with the latching structure of the other side wall.

25. The modular plug connector as claimed in claim 21, wherein the latching lug has a width which extends substantially over the entire width of the plug connector module.

26. The modular plug connector as claimed in claim 21, wherein the outer side of the side wall has, in the region in which the latching lug comes to lie, a depression region, which extends from an outer lateral surface of the outer side into the side wall, wherein the depression region and the latching lug are designed in such a way that the latching lug substantially does not protrude beyond the outer lateral surface.

27. The modular plug connector as claimed in claim 21, wherein the outer side of the side wall has, in the region in which the latching lug comes to lie, a depression region, which extends from an outer lateral surface of the outer side into the side wall, wherein the depression region and the latching lug are designed in such a way that the latching lug substantially does not protrude beyond the outer lateral surface in such a way that the latching lug is substantially flush with the outer lateral surface.

28. The modular plug connector as claimed in claim 21, wherein the side wall has, on its rear end face, a first positioning element, which cooperates with a second positioning element arranged on the plug connector module.

29. The modular plug connector as claimed in claim 28, wherein the first positioning element is a cam and wherein the second positioning element is a receptacle in which the cam engages; or wherein the second positioning element is a cam and wherein the first positioning element is a receptacle in which the cam engages.

30. The modular plug connector as claimed in claim 21, wherein the plug-connector-module-side guide element is at least one guide ridge and wherein the holding-frame-side guide element is at least one guide groove, wherein the at least one guide ridge engages in the at least one guide groove.

31. The modular plug connector as claimed in claim 21, wherein the guide elements on one of the two side walls are designed to differ from the guide elements on the other of the two side walls in such a way that a coding for the orientation of the plug connector modules is realized.

32. The modular plug connector as claimed in claim 21, wherein the guide elements extend over at least half the depth of the receiving space.

33. The modular plug connector as claimed in claim 21, wherein the guide elements have an insertion region and a main guide region, wherein the play between the plug connector module and the holding frame is greater in the insertion region than in the main guide region.

34. The modular plug connector as claimed in claim 21, wherein the at least one plug connector module has a lateral surface, wherein the spacing between the lateral surface and the guide elements is designed in such a way that two adjacent plug connector modules can be brought into contact with one another at the lateral surfaces.

35. The modular plug connector as claimed in claim 21, wherein the holding frame has two transverse walls, which are each arranged at the ends of the side walls and connect the side walls.

36. The modular plug connector as claimed in claim 21, wherein the holding frame has two transverse walls, which are each arranged at the ends of the side walls and connect the side walls, wherein the side walls and the transverse walls are designed as one piece.

37. The modular plug connector as claimed in claim 21, wherein the holding frame has a guide structure with which two holding frames are guided during the plug-in movement.

38. The modular plug connector as claimed in claim 21, wherein the holding frame has a guide structure with which two holding frames are guided during the plug-in movement, wherein the guide structure has coding elements.

39. The modular plug connector as claimed in claim 21, wherein the at least one plug connector module has a contact side, via which the functional element is accessible for a plug-in process with another plug connector and wherein the plug connector module has a connection side, via which the functional element can be connected to a connection element, such as a connection cable or a connection hose, wherein the plug connector module can be installed in the receiving space with its contact side first.

40. The modular plug connector as claimed in claim 39, wherein the latching lug protrudes from the connection side.

41. The modular plug connector as claimed in claim 21, wherein the side walls have a front end face and a rear end face, wherein the latching lug extends over the rear end face and wherein the front end face, when connected to a further plug connector, can be orientated with respect to the front end face of the further plug connector.

42. The modular plug connector as claimed in claim 21, wherein the plug connector module, as seen in the plug-in direction, projects out of the receiving space with a projecting region.

43. The modular plug connector as claimed in claim 17, wherein the plug connector module is designed in such a way that, between the side wall and the plug connector module, an intermediate space is produced, into which a projecting region of a plug connector module may project.
